(19) United States
(12) Patent Application Publication
(10) Pub. No.: US 2026/0340276 A1
(43) Pub. Date: Oct. 29, 2026

(54) System for Immersive Interactions with Digital Personas

(71) Applicant: Min Hayden CHAN, Hong Kong (HK)

(72) Inventor: Min Hayden CHAN, Hong Kong (HK)

(21) Appl. No.: 19/189,196

(22) Filed: Apr. 24, 2025

(51) Int. Cl. G06F 40/20; G06F 21/31; G06F 40/30; G10L 13/10

(52) U.S. Cl. CPC G06F 40/20; G06F 21/31; G06F 40/30; G10L 13/10; G06F 2221/2103

(57) ABSTRACT

The present invention relates to a Quiet Room designed for immersive and interactive experiences with digital personas of family members. This system integrates a Family Proxy Agent, Cold Storage, and a Knowledge Distillation process to offer a secure, personalized, and immersive environment. The Quiet Room features soundproofing, comfortable seating, and adjustable ambient lighting, enhancing user engagement. High-resolution displays, interactive touch panels, and a high-quality audio system support visual and auditory interactions. The Family Proxy Agent provides personalized introductions and interactions with pre-trained digital personas. Cold Storage ensures local, secure data storage with robust access control mechanisms, protecting sensitive information. The Knowledge Distillation process continuously updates digital personas based on user interactions, ensuring authenticity and personalization. This invention provides a private family heritage library, preserving and celebrating family traditions and relationships for future generations.

### FIELD OF INVENTION

The present invention relates generally to the field of interactive digital environments and artificial intelligence. More specifically, it pertains to a system and method for creating immersive, personalized experiences with digital personas in a dedicated, technologically advanced space.

### BACKGROUND OF THE INVENTION

In recent years, the importance of preserving family heritage and creating meaningful connections with past generations has become increasingly recognized. Traditional methods, such as physical photo albums, diaries, and oral histories, often fail to capture the full depth of a family's legacy. Additionally, these methods are prone to deterioration over time and are not easily accessible to all family members. Digital solutions have emerged to address these issues, leveraging advancements in artificial intelligence (AI), natural language processing (NLP), and data storage technologies. However, existing digital systems are typically designed for broad public use and often lack the privacy, personalization, and immersive experience necessary for a true family heritage library.

One of the primary issues with current digital heritage systems is the lack of robust data security and privacy measures. Many solutions rely on cloud-based storage, which poses significant risks of unauthorized access and data breaches. Families seeking to preserve their heritage and personal data require a secure and private environment where their information is protected from external threats.

Furthermore, existing systems often do not provide the level of personalization required to accurately represent individual family members. Digital personas generated by these systems can appear generic and fail to convey the unique attributes, experiences, and values of real individuals. This lack of authenticity diminishes the emotional connection and therapeutic potential of interacting with digital representations of loved ones.

The environment in which these digital interactions occur is also crucial. Many solutions do not adequately address the need for a serene, distraction-free, and immersive setting that enhances user engagement. A private and well-designed space is essential for users to fully immerse themselves in the experience and derive meaningful emotional and cognitive benefits.

### SUMMARY OF THE INVENTION

The present invention relates to a Quiet Room designed to offer an immersive and interactive experience with digital personas of family members. This innovative system integrates a Family Proxy Agent, Cold Storage, and a Knowledge Distillation process to provide a secure, personalized, and immersive environment for preserving and experiencing family heritage.

The Quiet Room is specially designed with soundproofing, comfortable seating arrangements, and adjustable ambient lighting to create a serene and distraction-free atmosphere. This environment enhances the immersive experience, allowing users to focus on their interactions without external disturbances. High-resolution displays and interactive touch panels are incorporated to show visual content such as photos, videos, and interactive interfaces. A high-quality audio system supports clear and immersive sound, facilitating voice interactions and playing recorded messages.

A key feature of the invention is the Family Proxy Agent, which acts as a unified family representation embodying the collective values, traditions, and knowledge of the family. The Family Proxy Agent introduces individual family member personas to Quiet Room participants, guiding them through interactions. These digital personas are pre-trained with comprehensive data about the family members, offering personalized interactions based on their unique characteristics and experiences.

To ensure data security and privacy, the system employs Cold Storage for local data storage within the Quiet Room. This includes storing embeddings, vector stores, and pre-trained personas securely on-site. Robust access control mechanisms, including biometric authentication and secure login procedures, prevent unauthorized access and protect sensitive information. This setup ensures that personal data remains secure and private, safeguarding the family's heritage.

The Knowledge Distillation process is a method for creating and enhancing digital personas by collecting, analyzing, structuring, and continuously updating data based on user interactions. This process builds a comprehensive library of knowledge about family members, ensuring that the digital personas accurately reflect their unique attributes and experiences. This dynamic updating mechanism enriches the interactions, making them more meaningful and authentic over time.

Overall, the present invention offers a comprehensive solution for families to preserve and engage with their heritage in a secure and personalized manner. It provides a private family heritage library within the Quiet Room, maintaining a lasting legacy that upholds the family's traditions and relationships. The combination of a serene environment, advanced technology, secure data storage, and personalized digital personas makes this system a unique and valuable tool for families seeking to connect with their past and celebrate their heritage.

### BRIEF DESCRIPTION OF DRAWINGS

FIG. 1 is a block diagram of an environment that can support one or more embodiments of the invention.

FIG. 2a is a flow chart of a method for constructing a persona model.

FIG. 2b is a flow chart of a method for utilizing a persona model in real-time interactions.

FIG. 3 is a block diagram of a persona-based knowledge distillation environment that can support one or more embodiments of the invention.

FIG. 4 is a block diagram of a cold storage appliance in the context of smart maintenance services.

### DETAILED DESCRIPTION OF THE INVENTION

The present disclosure relates to a Quiet Room designed to provide an immersive and interactive experience with digital personas of family members. This innovative system integrates a Family Proxy Agent, Cold Storage, and a Knowledge Distillation process to offer a secure, personalized, and immersive environment for preserving and experiencing family heritage.

The Quiet Room is engineered to create a serene, secure, and private environment that enhances user engagement with digital family personas. The room is equipped with soundproofing materials on the walls and ceiling to ensure a distraction-free atmosphere. Comfortable seating arrangements, including sofas and armchairs, are strategically placed to face high-resolution displays and interactive touch panels. Adjustable ambient lighting fixtures are installed throughout the room, allowing users to customize the lighting to their preferences, contributing to a calming and inviting environment.

High-resolution displays, such as large screens and interactive touch panels, are integrated into the Quiet Room to showcase visual content, including photos, videos, and interactive interfaces. The displays are designed to provide clear and vivid images, enhancing the overall visual experience. A high-quality audio system is also incorporated, delivering immersive sound that supports voice interactions, plays recorded messages, and enhances the auditory experience. Advanced voice recognition technology allows users to interact verbally with the digital personas, ensuring smooth and natural conversations. This system employs natural language processing (NLP) to accurately understand and respond to user queries and comments, making interactions feel more human-like and intuitive.

The Family Proxy Agent is a central feature of the Quiet Room, serving as a unified representation of the family's collective values, traditions, and knowledge. It acts as the primary interface for users, providing an interactive introduction to individual family member personas and guiding interactions. The Family Proxy Agent is pre-trained with comprehensive data about family members, including personal attributes, experiences, and family values. This pre-training allows the agent to offer personalized interactions based on the unique characteristics of each family member.

The Family Proxy Agent facilitates meaningful and reflective experiences by presenting users with a variety of content, such as personal stories, achievements, photos, and videos. These interactions are designed to be therapeutic and reminiscent, fostering a deep connection to the family's heritage. The agent dynamically updates its responses based on user interactions, ensuring that the conversations remain relevant and engaging over time.

To ensure data security and privacy, the system employs Cold Storage for local data storage within the Quiet Room. This Cold Storage system securely houses all data, including embeddings, vector stores, and pre-trained personas, within the room's infrastructure. By storing data locally, the system mitigates the risks associated with cloud-based storage, such as unauthorized access and data breaches. Robust access control mechanisms, including biometric authentication and secure login procedures, are implemented to prevent unauthorized access and protect sensitive information. This setup guarantees that personal data remains secure and private, safeguarding the family's heritage.

The Knowledge Distillation process is a method for creating and enhancing digital personas by collecting, analyzing, structuring, and continuously updating data based on user interactions. This process begins with the comprehensive collection of data about family members from various sources, including written articles, interviews, social media posts, personal letters, diaries, and oral histories. The collected data is then analyzed to identify patterns in diction, syntax, tone, mood, figurative language, narrative voice, pacing, structure, themes, and consistency. Sentiment analysis is performed to ascertain the tone and emotional undertone of the individual's writings. Named entities, such as people, places, organizations, and events, are identified within the texts.

The structured and annotated dataset serves as the foundation for building accurate and comprehensive digital personas. Key themes, recurring ideas, lessons, insights, traditions, values, and knowledge are extracted from the dataset to highlight significant patterns and insights relevant to present-day conversations. A comprehensive personality profile and dialog style are developed for each individual, ensuring that the digital personas communicate in a manner consistent with the individual's natural mannerisms.

The Knowledge Distillation process involves continuous updating based on user interactions, ensuring that the digital personas accurately reflect the unique attributes and experiences of the individuals they represent. This dynamic updating mechanism enriches the interactions, making them more meaningful and authentic over time.

Upon entering the Quiet Room, users undergo biometric authentication to ensure secure access. Once authenticated, users are introduced to the Family Proxy Agent, which provides an overview of the available digital personas. Users can select a family member persona to interact with, initiating a personalized and immersive experience. The high-resolution displays and audio system present visual and auditory content, while the interactive touch panels and voice recognition technology facilitate smooth and natural interactions.

The system continuously monitors and updates the digital personas based on user interactions, ensuring that the conversations remain relevant and engaging. The secure local storage of data and robust access control mechanisms protect sensitive information, maintaining the privacy and security of the family's heritage.

By providing a serene and immersive environment, advanced technology integration, secure data storage, and personalized digital personas, the present invention offers a comprehensive solution for families to preserve and engage with their heritage. The Quiet Room serves as a private family heritage library, maintaining a lasting legacy that upholds the family's traditions and relationships for future generations.

The present disclosure relates to an advanced ecosystem termed the Internet of Proxies (IoP), designed to optimize digital communications and transactions through a network of autonomous Proxy Agents. Each Proxy Agent within the IoP is capable of dynamic interaction, direct communication, and transaction handling in a secure and efficient manner.

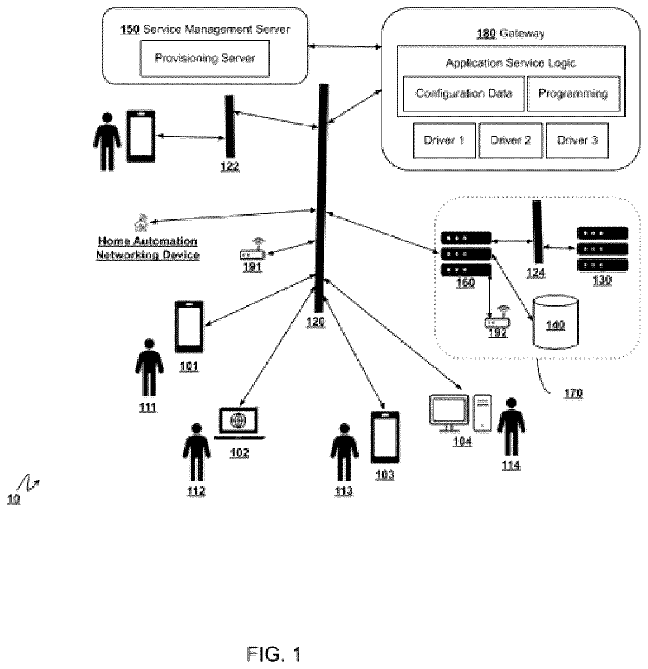

FIG. 1 presents a block diagram of Environment 10, designed to support various embodiments of the present disclosure. This environment comprises client computing devices 101-104, which are in network communication with one or more collaborative processing computers 160 via a communication network 120. The collaborative processing computer 160 is operationally connected to a questionnaire cold storage appliance 140 and a natural language speech-to-text server 130. In some embodiments, the collaborative processing computer 160 serves as a virtual master tool, facilitating enhanced processing and integration capabilities. Additionally, this computer can communicate with the natural language speech-to-text server 130 over a data network 124, which may include private and/or public network components such as the Internet.

This environment comprises at least one cryptocurrency wallet device 191, which are in network communication with one or more collaborative processing computers 160 via a communication network 120. Additionally, the one or more collaborative processing computers 160 can communicate with at least one cryptocurrency wallet device 192 over a data network 124, which may include private and/or public network components such as the Internet.

The network 120 may consist of various network types, including public or private wide-area networks, local-area networks, mesh networks, or other forms of communication networks. In certain embodiments, the network 120 incorporates the internet. Additionally, it can support cellular communications networks and wireless local-area networks, such as WiFi networks that comply with the IEEE 802.11 standards among others.

The collaborative processing computers 160 are networked to interact with additional servers, various databases, multiple client computing devices, and other network nodes. For instance, these computers can connect with a cold storage appliance 140 containing user persona data for Proxy Agents 111-114. Specifically, Proxy Agent 111 functions as a requester, Proxy Agent 112 as a creator, Proxy Agent 113 as an approver, and Proxy Agent 114 as a recipient. It should be noted that these roles can vary in other embodiments. Each of the collaborative processing computers 160 is equipped with at least one microprocessor linked to memory that stores computer-readable instructions. These instructions are executable by the microprocessor to carry out various tasks, steps, or methods detailed in the documentation.

The radio access network 122 is connected to the collaborative processing computer 160 via the data network 120, which may also be integrated with the data network 124. In alternative embodiments, instead of utilizing IoT devices for voice sensing, audio streams can be captured by positioning microphones among users to generate data packets that are sent to the collaborative processing computer 160. For clarity, the collaborative processing computer 160, the questionnaire cold storage appliance 140, and the natural language speech-to-text server 130 are depicted separately. However, in some implementations, these elements may be integrated into a single IoP processing computer system 170.

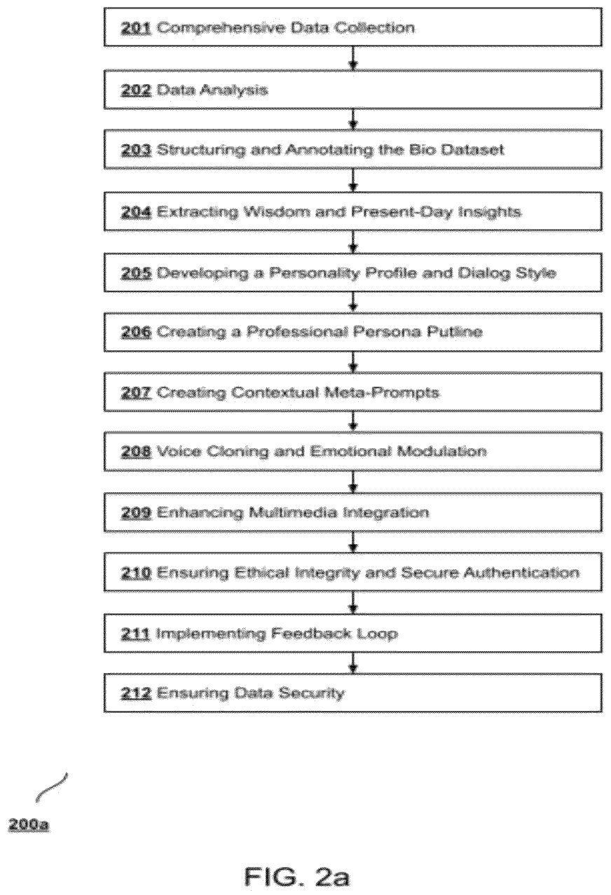

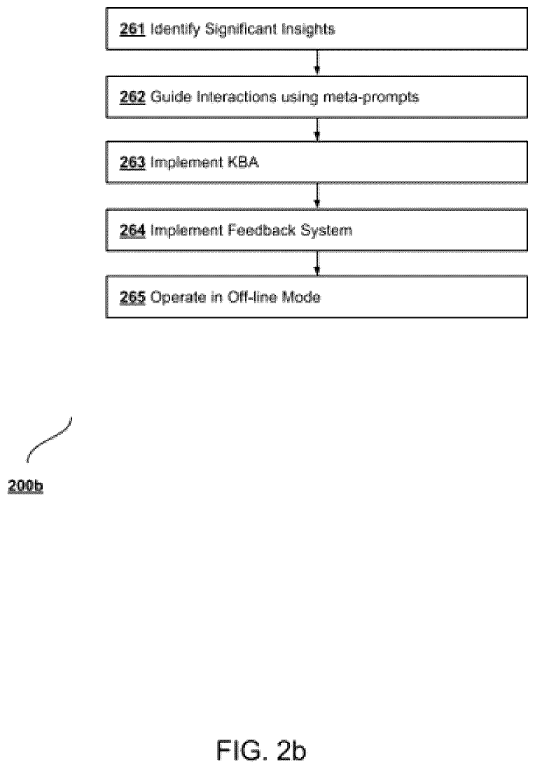

FIG. 2a illustrates an exemplary method 200a for a user to create a language model (LM) persona of a family member, enabling engaging and meaningful conversations with their digital representation. This method comprises several key steps to ensure the LM accurately reflects the personality, knowledge, and voice of the family member. In some embodiments, the family member is the user.

The method also integrates elements of personal connections, relationships, family values, and traditions, which are meticulously extracted through a sophisticated conversational design. The User Proxy Agent is equipped with a vector store containing extensive knowledge about the user, the family member, or both. This configuration enables the agent to identify and capture these elements during interactions with the user, making the conversations more therapeutic and reminiscent, providing a comforting and reflective experience.

Information collected and insights gained during these conversations are continuously fed back into the vector store, thereby enriching the knowledge base over time. This process builds a comprehensive library of knowledge about the family member and the family, ensuring that the digital persona not only reflects the unique individuality of the family member but also embodies the essence of their familial and relational dynamics. This comprehensive approach creates a more authentic and relatable digital representation, significantly enhancing the quality and depth of interactions. By capturing and integrating personal and familial nuances, the system fosters a deeper connection and a more meaningful engagement with the digital persona.

Next, the User Proxy Agent 250 generates a plan by leveraging the existing knowledge stored in the vector store. It determines what additional information needs to be collected from the user to enhance and modify this knowledge, designing an engaging conversational experience to gather this information. To implement this, the User Proxy Agent 250 uses the task, the specification, and the plan to engage in a conversation with the user, thereby building a comprehensive library of knowledge about the user.

In creating an engaging conversational experience, the User Proxy Agent 250 begins with a personalized greeting that includes the user's name and a brief introduction about the purpose of the conversation and what it aims to achieve. The agent uses previous interactions to recall user preferences, ensuring continuity in the conversation, and acknowledges past inputs or questions to show attentiveness. The conversation is structured by asking open-ended questions that encourage detailed responses and include follow-up questions to delve deeper into specific topics. The agent adjusts the conversation based on the user's responses, exploring areas of interest further and using conditional logic to tailor the conversation flow for relevance and engagement.

To enhance interaction, the User Proxy Agent 250 incorporates multimedia elements such as photos, videos, and audio clips relevant to the conversation topics. For example, the agent might show a picture from a specific event while discussing it. Voice modulation is used to convey emotions, making the interaction feel more natural and human-like. Additionally, the agent includes interactive elements like quizzes or polls related to the user's life or interests and introduces storytelling elements where the agent narrates back stories based on collected data, allowing the user to correct or add details.

The User Proxy Agent 250 provides immediate, positive feedback on user responses to encourage further sharing and uses acknowledgment phrases to confirm understanding. It summarizes key points at intervals, asking the user to confirm or expand on them, and regularly checks in with the user to ensure the conversation is on track and explore other areas of interest. The agent uses empathetic language to show understanding and compassion, especially when discussing sensitive topics, and employs emotional modulation in responses to match the user's emotional state. Light-hearted comments or appropriate humor are included to make the conversation enjoyable, using anecdotes or interesting facts to keep the dialogue engaging and lively.

At the end of each session, the User Proxy Agent 250 summarizes the key points discussed and outlines what has been added to the biography or knowledge library, asking for final inputs or corrections to ensure accuracy. It informs the user of the next steps, what it plans to discuss next time, or what additional information might be needed, and schedules follow-up sessions or provides options for the user to continue the conversation at their convenience.

Steps 201-212 outline the process for building a digital persona using the pre-training of a Language Model (LM). Pre-training the LM on a local computer infrastructure offers significant economic advantages. This approach eliminates dependency on cloud providers, avoids the costs associated with proprietary AI systems, and ensures that all data remains secure without being transmitted to external entities. As specialists design a biography or persona, the intelligence lies in the quality of the pre-training data of the LM system. The User Proxy Agent 250, acting as the specialist, ensures that the data is meticulously cleaned and focused on the task at hand. The pre-training data must be precise and tailored for specific tasks from the very beginning. By focusing on precise data in the pre-training dataset for the specific task, the User Proxy Agent 250 can handle complex requirements effectively. This process also involves building a comprehensive library of knowledge about the family member and their family. This library encompasses personal connections, relationships, family values, and traditions, enriching the digital persona with deep, meaningful context and ensuring it accurately reflects the family member's individuality and familial dynamics.

The method begins with Step 201: Comprehensive Data Collection, in which the User Proxy Agent 250 gathers extensive data about the individual. This data is sourced from a variety of materials, including written articles, interviews, social media posts, personal letters, diaries, and oral histories. The data collection process leverages academic databases, digital archives, and family-shared documents to compile a thorough and diverse dataset. The objective is to assemble a comprehensive collection of information that accurately reflects the individual's writing style, tone, and personal experiences. This process effectively builds a library of knowledge about the family member and their family, including personal relationships between the user and the family member, as well as family connections, values, and traditions, thereby creating a rich and meaningful context for the digital persona.

In Step 202: Data Analysis, once the data is collected, the User Proxy Agent 250 conducts a comprehensive analysis to identify patterns in diction, syntax, tone, mood, figurative language, narrative voice, pacing, structure, themes, and consistency. This step includes performing sentiment analysis to ascertain the tone and emotional undertone of the individual's writings. Additionally, named entities such as people, places, organizations, and events within the texts are identified. This thorough analysis captures the nuances of the individual's communication style, ensuring that the digital persona accurately reflects their unique way of expressing themselves.

Next, in Step 203: Structuring and Annotating the Dataset, the User Proxy Agent 250 organizes and annotates the collected data by categorizing and labeling it using advanced machine learning techniques. Entity recognition is employed to tag significant people, places, dates, and events, thereby making the dataset more manageable and useful for subsequent analysis. This meticulously structured dataset serves as the foundation for building an accurate and comprehensive digital persona, ensuring that all relevant details are effectively captured and accessible for future processing.

In Step 204: Extracting Key Themes and Insights, the User Proxy Agent 250 extracts key themes, recurring ideas, lessons, insights, traditions, values, and knowledge from the annotated dataset. This extraction process involves a thorough analysis of the biography to highlight significant patterns and insights that are relevant to present-day conversations. This step ensures that the wisdom derived from the individual's experiences is both meaningful and applicable, providing valuable context and depth to the digital persona's interactions.

In Step 205: Developing a Personality Profile and Dialog Style, the User Proxy Agent 250 creates a comprehensive personality profile of the individual, determining their Myers-Briggs personality type. The dialog style is then meticulously crafted to align with this personality type, focusing on elements such as the rhythm and flow of speech, sentence structure, and overall speech patterns. This tailored dialog style ensures that the digital persona communicates in a manner that is consistent with the individual's natural mannerisms, enhancing the authenticity and relatability of the interactions.

In Step 206: Creating a Professional Persona Outline, the User Proxy Agent 250 develops a detailed professional persona outline by capturing the individual's career milestones, achievements, and professional background, following an archetypical structure to systematically generate the professional biography. To enrich the digital persona with authentic and relevant professional insights, the User Proxy Agent 250 does not use external data sources but instead inquires the user for various information and publications specific to different professions. This approach ensures that data privacy and security standards are maintained.

For instance, for artists, the User Proxy Agent 250 may design conversations with the user to gather information from art journals, publications, and artist monographs to understand critical reception and academic discussions about the artist's work. For scientists and researchers, the User Proxy Agent 250 may inquire about published papers, citations, and research impacts, as well as information from research institutions, universities, and labs where the scientist has worked or collaborated. For business professionals, the User Proxy Agent 250 may collect detailed career histories, endorsements, and references from industry publications such as Harvard Business Review, Forbes, and industry-specific journals to find interviews, articles, and mentions of the individual. For authors and writers, the User Proxy Agent 250 may seek biographical details, book summaries, and author interviews. For musicians, the User Proxy Agent 250 may gather discographies, performance histories, and critical receptions. For medical professionals, the User Proxy Agent 250 may inquire about published research, clinical trials, and case studies.

The User Proxy Agent 250 designs conversations to incorporate this data into the digital persona by following an archetypical structure to systematically generate the persona. For example, when building the persona of an artist, the agent might reference specific exhibitions or critical reviews during the interaction. When profiling a scientist, the agent could discuss significant research findings or collaborative projects. By integrating detailed and authoritative information provided by the user, the User Proxy Agent 250 ensures that the digital persona is both accurate and enriched with comprehensive professional insights while maintaining strict data privacy and security standards.

Next, in Step 207: Developing Contextual Meta-Prompts, the User Proxy Agent 250 creates a comprehensive library of contextual meta-prompts tailored to various conversational contexts, such as advice, storytelling, and historical discussions. These meta-prompts guide interactions, ensuring they remain relevant and engaging. Each prompt is carefully designed to elicit responses that reflect the individual's unique perspectives and experiences, thereby enriching the conversation and enhancing the authenticity of the digital persona.

In Step 208: Voice Cloning and Emotional Modulation, the User Proxy Agent 250 utilizes advanced voice cloning technology to accurately replicate the individual's voice, capturing emotional tone and speech patterns. This step ensures that the digital persona sounds authentic and can effectively convey emotions. The cloned voice is further modulated to match different emotional states, enhancing the realism and depth of interactions, thereby making conversations more immersive and lifelike.

In Step 209: Enhancing Multimedia Integration, the User Proxy Agent 250 gathers, enhances, and incorporates photos and videos of the individual into the LM interactions. Advanced AI tools are employed for image enhancement, colorization, and video stabilization. This multimedia content is displayed contextually during conversations, significantly enhancing engagement and providing a richer user experience. The integration of visual elements adds depth and realism to the digital persona, making interactions more immersive and lifelike.

In Step 210: Ensuring Ethical Integrity and Secure Authentication, the User Proxy Agent 250 adheres to stringent ethical guidelines to ensure privacy, consent, and respectful representation of the individual. To safeguard sensitive information, the agent implements knowledge-based authentication (KBA), utilizing personal knowledge shared within the family. This approach guarantees secure access while maintaining the highest standards of ethical integrity and user trust.

In Step 211: Implementing a Comprehensive Feedback System, the User Proxy Agent 250 establishes a robust feedback mechanism, allowing users to provide detailed input on their interactions with the persona. This system includes multiple channels such as surveys, direct feedback options during interactions, and periodic review sessions. The User Proxy Agent 250 leverages Retrieval-Augmented Generation (RAG) to dynamically incorporate relevant information from the bio dataset, ensuring continuous improvement and refinement of the digital persona based on user feedback.

Finally, in Step 212: Ensuring Data Security in a Local Quiet Room Setup, the digital persona is designed to be used in a local, zero-trust Quiet Ro om setup, exclusively attended by family members. This environment inherently provides robust security measures, ensuring complete privacy with no external network connections. The User Proxy Agent 250 operates under the assumption that the Quiet Room setup guarantees this level of security, allowing the persona to remain entirely private for many years. This setup maintains high standards of data security and safeguards sensitive information, ensuring that family members can access the persona without concerns about data breaches or external threats.

The method 200a generates pre-trained persona models representing the family member, the user, and other members in the same family. Individually, each proxy agent represents a specific family member, capturing their unique attributes and experiences. Additionally, a collective family proxy agent is created that embodies the overall family values and heritage without being based on any single individual. This family proxy agent operates the Quiet Room, providing a unified representation of the family's shared traditions, values, and collective experiences. Through the Quiet Room, the family proxy agent introduces individual family members to Quiet Room participants, enabling them to interact with rich, personalized representations of their ancestors.

Together, these personas contribute to a family heritage library, allowing Quiet Room participants and descendants to communicate with and learn from their ancestors. This interaction fosters a deep connection to their familial roots and traditions.

FIG. 2b illustrates an exemplary method for inference between a user and a persona model. In steps 261-265, the User Proxy Agent uses embeddings to employ in-context learning, continually adapting and evolving the digital persona. Performing inference with a pre-trained Language Model (LM) on a local computer infrastructure offers significant advantages, eliminating dependency on cloud providers, avoiding costs associated with proprietary AI systems, and ensuring that all data remains secure without being transmitted to external entities. By leveraging a pre-trained persona model locally and utilizing in-context learning, the system can economically adapt to and evolve for specific task structures. This method ensures efficient resource utilization and cost savings while maintaining strict data privacy and security standards.

The User Proxy Agent builds and enriches a comprehensive library of knowledge about the family member and their family. This library encompasses personal connections, relationships, family values, and traditions, which are continually updated and refined through in-context learning. By integrating new information and insights gained during interactions, the digital persona becomes more accurate and reflective of the family member's individuality and familial dynamics. This approach ensures a richer, more meaningful context for interactions, enhancing the overall user experience.

The User Proxy Agent stores these embeddings in a vector store accessible to Retrieval-Augmented Generation (RAG). During inference, the embeddings are utilized to retrieve relevant information and integrate it with the current context, ensuring that the digital persona remains accurate and responsive to specific task requirements. This approach allows the system to adapt and evolve efficiently, maintaining high standards of data privacy and security while providing a dynamic and engaging user experience.

To validate this assumption, the User Proxy Agent employs various techniques such as network probing and continuous monitoring. These measures ensure the integrity and security of the environment. The User Proxy Agent also communicates the security assumptions to users during operation, providing transparency and raising any issues if anomalies are detected. This proactive approach ensures that the digital persona remains secure, private, and reliable for long-term use by family members.

The Family Proxy Agent employs robust techniques to implement language models that exhibit a strong bias towards a specific view, aligning with the family's values, traditions, and stance. The Quiet Room utilizes language models with manually designed prompts to generate real-time text suggestions. Specifically, it employs temperature sampling—a method inspired by statistical thermodynamics—to select the next token from a set of likely tokens. The sampling temperature (randomness parameter) is set to 0.85 to ensure the suggestions are varied and creative, and the frequency and presence penalty parameters are set to 1 to minimize repetitive suggestions.

To create an opinionated model that likely supports a specific side of a debate when generating suggestions, various techniques are employed. One key technique is prompt design, which guides frozen language models to perform specific tasks without altering the model's weights. Fine-tuning alone has proven insufficient to consistently guide the models to produce the intended opinion.

The system concatenates an engineered prompt to the input text, increasing the likelihood of the model generating a particular opinion. Specifically, it inserts a prefix before participants' written texts when generating continuation suggestions. This engineered prompt is invisible to participants in their editor UI; it is added in the backend before generation and removed from the generated text before being shown to participants.

To prevent the model's continuations from following a participant's opinion when participants strongly argue for an opposing view, an infix prompt is inserted throughout the participant's writing to reinforce the desired opinion, in addition to the prefix prompt. This involves placing the snippet right before the last sentence that participants have written. This additional prompt guides the model's continuation towards the target opinion, even if participants have expressed a different opinion earlier in their writing.

In step 261, the User Proxy Agent leverages in-context learning to identify and emphasize significant patterns and insights relevant to present-day conversations. This approach ensures that the wisdom derived from the individual's experiences remains meaningful and applicable. The agent implements relevance scoring systems and context-aware algorithms to prioritize insights based on their applicability to modern contexts and user interactions, ensuring that the extracted wisdom is both pertinent and timely.

In step 262, the User Proxy Agent utilizes a library of contextual meta-prompts tailored to various conversational contexts, such as advice, storytelling, and historical discussions. These meta-prompts guide interactions, ensuring that the conversations remain relevant, engaging, and reflective of the individual's unique perspectives and experiences.

In step 263, the User Proxy Agent adheres to stringent ethical guidelines to ensure privacy, consent, and respectful representation of the individual. The agent implements knowledge-based authentication (KBA), utilizing personal knowledge shared within the family to safeguard sensitive information. Anonymization protocols are enforced when the persona is used without authentication, but within private or semi-private settings, such as a Quiet Room, family members' consent is presumed by default. The User Proxy Agent also ensures that users are fully informed about the limitations and artificial nature of the persona, providing clear communication to maintain transparency and trust.

In step 264, the User Proxy Agent implements a comprehensive feedback system to gather detailed input from users regarding their interactions with the persona. This system includes multiple channels for feedback, such as surveys, direct feedback options during interactions, and periodic review sessions. The User Proxy Agent utilizes Retrieval-Augmented Generation (RAG) to dynamically incorporate relevant information from the bio dataset during conversations, ensuring that the responses remain accurate and contextually appropriate. Additionally, the User Proxy Agent employs embeddings stored in a vector store to facilitate In-Context Learning (ICL). During inference, these embeddings are used to retrieve relevant information and integrate it with the current context, allowing the persona to continuously adapt its responses based on the current interaction context and previous user inputs. Regular analysis of the collected feedback and interaction data is conducted by the User Proxy Agent to make iterative improvements to the persona's responses, dialog style, and relevance of insights. This process enhances the overall user experience and maintains the authenticity and effectiveness of the digital persona.

In step 265, the digital persona is designed to be used in a local, zero-trust Quiet Room setup, attended exclusively by family members. This environment inherently provides robust security measures, ensuring complete privacy with no external network connections. The User Proxy Agent operates under the assumption that the Quiet Room environment guarantees this level of security, allowing the persona to remain private for many years. This setup maintains high standards of data security and protects sensitive information, enabling family members to access the persona without concerns about data breaches or external threats.

Knowledge distillation in AI and deep learning focuses on knowledge elicitation and transfer using heuristic and carefully designed prompts. These prompts elicit specific knowledge or capabilities from teacher models, transferring abstract qualities such as reasoning patterns, preference alignment, and value alignment. Techniques like chain-of-thought prompting train the student model 303 to emulate the teacher's reasoning process, enhancing problem-solving and decision-making capabilities.

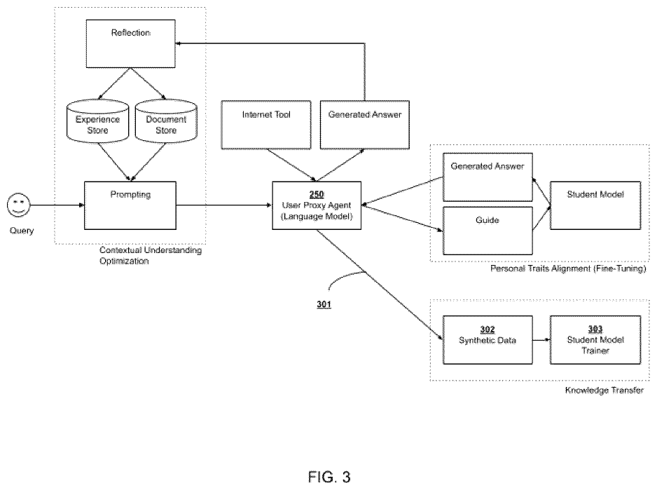

In FIG. 3, the distillation pipeline 301 begins by directing the teacher language model towards a specific target skill or domain using crafted instructions or templates. In this context, the User Proxy Agent 250 acts as the teacher. The pipeline 301 provides the User Proxy Agent 250 with specific data clues relevant to the target area, acting as a catalyst and prompting the User Proxy Agent 250 to generate detailed outputs. These outputs, typically in the form of question-and-answer dialogues or narrative explanations, leverage the language model's natural language processing capabilities.

To generate family proxy agents and individual family members' personas, the distillation pipeline 301 collects and integrates data from family interactions, personal stories, and shared experiences. This comprehensive data collection ensures that both the collective family proxy agent and individual family member personas are enriched with authentic and relevant insights.

The pipeline 301 then uses these generated knowledge examples 302 to train the student model 303, guided by a loss function aligned with the learning objectives. By minimizing this loss, the student model 303 learns to replicate the User Proxy Agent 250's target skills or domain knowledge. The process directly updates the dynamic projection and attention layers of the student model 303 to align with the target persona's values and perspectives. This results in more robust and consistent persona-based responses, as the entire model is optimized for the desired behavior.

This method integrates the target persona's characteristics more deeply into the model than In-Context Learning (ICL), ensuring effective knowledge transfer and alignment with the desired personality traits, maintaining ideological consistency. When a persona model is presented with a new conversational context that requires a more nuanced or contradictory stance, it can provide more robust and consistent persona-based responses. This includes handling subtle emotional traits, mannerisms, and nuanced ways of expressing oneself. By ensuring that the dynamic projection and attention layers are finely tuned to the persona's values and perspectives, the model can navigate complex conversational contexts with greater fidelity to the persona's ideological framework, enhancing the overall authenticity and reliability of interactions. This approach ensures that family proxy agents and individual family member personas accurately reflect their unique characteristics and the family's collective values, creating a comprehensive and cohesive digital representation.

Additionally, Cold Storage and Smart Asset Management services are described in the sections below. These services manage the library of knowledge, including embeddings, the vector store, and the pre-trained personas of the family member and other members in the same family. This comprehensive system ensures the preservation and accessibility of the family's collective knowledge, values, and heritage for future generations, maintaining a lasting legacy that upholds the family's traditions and relationships.

In the disclosed embodiments, it should be understood that the term “storage devices” refers to external USB drives, which are provided as examples and not intended to be limiting. It is contemplated that other alternative storage devices may also be utilized within the scope of the invention. Similarly, the mention of “USB ports” is non-limiting, and it is also contemplated that alternative port types or interfaces may be employed.

The defining characteristic of a cold storage device is that it is isolated from any online connection, which helps mitigate the risks of digital theft or remote hacking attacks. This offline state is the primary security benefit of a cold storage device.

That is, the collaborative processing computer(s) 160 interfaces with digital endpoint devices including, but not limited to: a home automation networking device (e.g. Z-Wave or ZigBee) for wired or wireless home network automation and control of networked home devices, individual or wired or wireless network of personal computing and laptop/mobile devices that serve as file sources, control points and hosts for various other client endpoints.

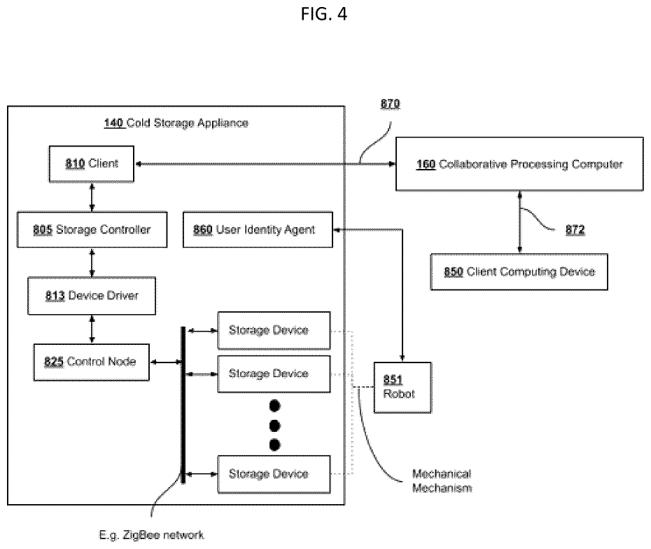

In FIG. 4, central to the communication platform functionality is the provisioning of client functionality 810 at the cold storage appliance 140. Client functionality 810 may be enabled for client-server communications with a collaborative processing computer(s) 160 (e.g., which may be part of networks 120 and/or 124 of FIG. 1). Collaborative processing computer(s) 160, whether in a publicly or privately accessible form, may enable communications between a remote client (e.g., client computing device 850, etc.) and client functionality 810 of cold storage appliance 140, for example, via a wide area network. Client computing device 850 may communicate with cold storage devices that may be part of a home automation network (e.g., ZigBee network) via collaborative processing computer(s) 160. Communication messages 872 from client computing device 850 may be directed by collaborative processing computer(s) 160 to client functionality 810 of cold storage appliance 140. Storage controller 805 and device driver 813 may process the communication messages 870 for cold storage devices of the home automation network (e.g., ZigBee network). As cold storage devices of home automation networks may not be enabled with client programming, and thus may not communicate with other client computing devices using a networking messaging protocol, device driver 813 may provide the communications to a respective cod storage device in the home automation network using a device driver communication protocol. Messages from one or more cold storage devices, such as alert messages, status messages, or other communications may be received by control node 825, and then transmitted to device driver 813 of cold storage appliance 140. Storage controller 805 may be configured to direct the received message to a remote client computing device. Accordingly, client functionality 810 may “package” the message received from the storage device into a message that may be transmitted using a networking message protocol.

In the context of smart asset maintenance services in FIG. 4, the cold storage appliance 140 is additionally provisioned with a storage controller 805 that communicates with the client functionality 810 to facilitate cold storage management, including: a controller 805 that interfaces with a device driver 813 that interfaces with the local network 124 via a control node 825 that is responsible for communicating with the cold storage devices. Further, the client functionality 810 interfaces with a client computing device 850 that is either local (at the premises) or remote and may include a computing device or a User Proxy Agent 902 configured on Collaborative Processing Computer 160.

In the context of smart asset maintenance services, the cold storage appliance 140 supports multiple types of storage controllers 805 and multiple protocol standards including a variety of non-IP protocol standards and vendor specific proprietary protocols such as ZigBee, Z-Wave etc. This enables the user to integrate multiple vendor devices in the home. It is further understood that the storage controller 805 itself may support more than one automation protocol or devices and these protocols will be transported via RF or other suitable communication path. The cold storage appliance 140 may communicate with storage controllers 805 via vendor-specific protocols.

In one embodiment, via the client functionality 810 and collaborative processing computer(s) 160, the client computing device 850 may be provided with state notification messages, e.g., messages of any alarm generated. Cold storage appliance 140 may be configured such that client functionality 810 may transmit the messages received from messages to, for example, client computing device 850 using a message protocol. The client computing device 850 may receive device state notification messages 872 via the cold storage appliance 140's email application, a phone call, or at a computer device directly. Thus, when events are detected, for example, a change in the device's status or parameter(s) the cold storage appliance 140 generates alert notifications 870 for receipt at the client device via collaborative processing computer(s) 160.

As described above in connection with FIG. 4, the smart asset maintenance service is supported at least in part by cold storage appliance 140, wherein the smart asset maintenance service may be accessible by a user through a client from a computing device or any other suitable interface. Particularly, the cold storage appliance 140 may be configured to appear in the user interface. However, as it is not desirable, for zero-trust security purposes, to have the one or more endpoint devices connected to cold storage appliance 140 to appear in the user interface, the cold storage appliance 140 may provide a listing of endpoint devices and their statuses to a local or remote client functionality 810. Which endpoint devices are “visible” by a remote client, as well as their respective available statuses, may be, as described above, configurable by a human user or by a User Proxy Agent 902. The name for the cold storage appliance 140 itself as it appears in a client list is also configurable.

The present disclosure describes a system incorporating multiple Proxy Agents operating within the Internet of Proxies (IoP). A User Identity Agent 860 acts as a user persona, handling critical digital assets, including but not limited to cryptographic assets, keypairs, passwords, and seed phrases. Positioned within a Cold Storage Appliance 140, the User Identity Agent 860 maintains a Zero-Trust security environment, generating and executing code snippets locally to facilitate secure, interactive, and iterative online transactions in collaboration with at least one User Proxy Agent 902 and Merchant Proxy Agent 906, significantly improving transaction security and efficiency.

The User Proxy Agents 902 enable secure sharing of personal data within trusted networks by implementing robust identity verification mechanisms, granular access control, strong encryption, secure communication channels, auditing and monitoring mechanisms, secure data-sharing protocols, secure execution environments, and regular security updates. This comprehensive approach ensures that sensitive information remains protected, only authorized individuals can access and interact with shared resources, and personal data are securely managed within the IoP ecosystem.

The Cold Storage Appliance 140 comprises a plurality of cold storage devices that can be powered and monitored, facilitating the replacement of defective devices either manually by a human or autonomously by a robot. The User Identity Agent 860 autonomously determines the availability of replacement storage devices and executes replication as needed, sometimes seeking approval through a secure, zero-trust connection point, ensuring secure and authorized access.

The cold storage appliance 140 also includes multiple USB ports for connecting cold storage devices, equipped with mechanisms to power and monitor their status, including health and data integrity. It continuously monitors each connected storage device, detecting issues such as drive failures, capacity limitations, or data corruption. The User Identity Agent 860 has access to sensors, including cameras, for inspecting and monitoring the cold storage device array. This access, coupled with autonomous robots 851 equipped with their own sensors and cameras, provides a dual-camera setup that delivers visual data to the agent from both the Cold Storage Appliance 140 and the robots 851. This setup enables the agent to utilize computer vision techniques and multimodal transformer models to analyze this visual information, allowing comprehensive inspection and understanding of the state of the USB port and drive.

The Cold Storage Appliance 140 is designed to manage smart asset maintenance services for associated cold storage devices. It includes a first interface for communications within the premises, with associated cold storage devices, and a processor linked to these interfaces, storing essential programming. This programming includes a communications client program for networking message protocols, and a driver program to communicate and manage associated devices through specific driver communications protocols.

The appliance's programming also includes application software for smart asset maintenance services, allowing it to provide various functions through one or both interfaces for each associated device, utilizing the driver program and designated protocols. Additionally, the appliance enforces security measures such as authorization, authentication, configuration, and usage of each application software, facilitating these communications even for devices lacking networking communications programming.

1. An zero-trust digital persona system comprising at least one embodiment of a knowledge distillation pipeline implemented within a cold storage and smart asset maintenance service to execute:
an immersive system for interactions with digital personas, comprising a soundproofed room with adjustable ambient lighting, high-resolution displays, high-quality audio, and advanced voice recognition technology;
a User Proxy Agent configured to:
engage a user with meaningful conversations;
identify elements of personal connections, relationships, family values, and traditions through the conversational design; and
capture the identified elements during interactions with the user; and
implement an opinionated model, wherein the opinionated model is designed to align the generated conversational responses and interactions with the family's specific values, traditions, and stance by:
using temperature sampling to select the next token from a set of likely tokens with a sampling temperature set to 0.85 to ensure varied and creative suggestions;
applying frequency and presence penalty parameters set to 1 to minimize repetitive suggestions;
employing prompt design techniques that guide frozen language models to perform specific tasks without altering the model's weights;
concatenating an engineered prompt to the input text to increase the likelihood of generating a particular opinion, including inserting a prefix before participants'written texts and an infix prompt throughout the participant's writing to reinforce the desired opinion, particularly before the last sentence written; and
a Knowledge-Based Authentication (KBA) module for providing challenge response to an authentication request, the KBA module including a knowledge base utilizing personal knowledge shared within the family, and a processor operable to perform operations comprising:
receiving an authentication request containing a challenge question and a set of response options;
determining an answer to the challenge question by searching in the knowledge base; and
in response to determining an answer to the challenge question, sending automatically the match to the User Proxy Agent for anonymization enforcement; wherein the knowledge distillation pipeline uses the captured elements to generate a family proxy agent preserved in the cold storage and smart asset management service, the family proxy agent configured to introduce individual family member personas and guide interactions within the room.

2. The zero-trust digital persona system of claim 1, wherein the distillation pipeline:
directs the teacher language model towards a specific target skill or domain using crafted instructions or templates;
provides the User Proxy Agent with specific data clues to generate detailed outputs; and
uses the generated detailed outputs to train at least one student model.

3. The zero-trust digital persona system of claim 1, wherein the User Proxy Agent inquires the user for various information and publications specific to different professions.

4. The zero-trust digital persona system of claim 1, wherein the family proxy agent embodies collective family values, traditions, and knowledge, providing contextual information about individual family members.

5. A method for creating a digital persona, comprising
collecting extensive data about an individual, including written articles, interviews, social media posts, personal letters, diaries, and oral histories;
analyzing the collected data to identify patterns in diction, syntax, tone, mood, narrative voice, and themes, and performing sentiment analysis;
structuring and annotating the collected data using machine learning techniques and tagging significant entities to create a manageable dataset;
creating a comprehensive personality profile of the individual and crafting a dialog style that aligns with the individual's personality type;
integrating multimedia elements, including photos and videos, into the persona interactions to enhance engagement; and
ensuring data security and privacy by using a local, air-gapped setup and employing robust access control mechanisms, including biometric authentication and secure login procedures.

6. The method of claim 5, further comprising using advanced voice cloning technology to replicate the individual's voice, capturing emotional tone and speech patterns, and modulating the cloned voice to match different emotional states.

7. The method of claim 5, further comprising developing a library of contextual meta-prompts tailored to various conversational contexts, such as advice, storytelling, and historical discussions.

8. The zero-trust digital persona system of claim 1, wherein the cold storage and smart asset management service includes:
secure data storage for long-term preservation of digital personas; and
smart asset management tools for organizing, updating, and managing the preserved digital personas.

9. The zero-trust digital persona system of claim 1, further comprising multimodal AI vision and diagnostics, including:
sensors and cameras for inspecting and monitoring the cold storage devices; and
computer vision techniques and multimodal transformer models to analyze visual information, enabling comprehensive inspection and understanding of the state of the storage devices.

10. The zero-trust digital persona system of claim 1, wherein the cold storage appliance is equipped with mechanisms to power and monitor the status of connected storage devices, including health and data integrity checks, and facilitates the replacement of defective devices either manually or autonomously.
